(19) United States
(12) Patent Application Publication
(10) Pub. No.: US 2026/0300213 A1
(43) Pub. Date: Oct. 1, 2026

(54) UNIVERSAL SERIAL BUS DEVICE AND OPERATION METHOD THEREOF

(71) Applicants: Chung-Ping Hsu, Taipei City (TW); Ming Hsun Lu, New Taipei City (TW); Yi Chang Hsu, New Taipei City (TW)

(72) Inventors: Chung-Ping Hsu, Taipei City (TW); Ming Hsun Lu, New Taipei City (TW); Yi Chang Hsu, New Taipei City (TW)

(73) Assignee: ITE Tech. Inc., Hsinchu (TW)

(21) Appl. No.: 19/302,056

(22) Filed: Aug. 17, 2025

(30) Foreign Application Priority Data
Apr. 1, 2025 (TW) 114112585

(51) Int. Cl. G06F 13/42

(52) U.S. Cl. CPC G06F 13/4282; G06F 2213/0042

(57) ABSTRACT

An USB device and an operation method thereof are provided. USB controllers take turns to reset an USB physical layer circuit during an initial setting period to obtain corresponding device controller initial addresses and descriptors. A USB determining processor queues a ready flag of a USB controller indicating that data corresponding to a host request of a host is ready into a ready flag queue waiting list. The USB determining processor transmits data of a corresponding USB controller to the host according to the ready flag queue waiting list.

### CROSS-REFERENCE TO RELATED APPLICATION

This application claims the priority benefit of Taiwan application serial no. 114112585, filed on Apr. 1, 2025. The entirety of the above-mentioned patent application is hereby incorporated by reference herein and made a part of this specification.

### BACKGROUND

### Technical Field

The disclosure relates to an electronic device, and in particular relates to a Universal Serial Bus device and an operation method thereof.

Description of Related Art

Currently, the most widely used connection interface in computer peripheral devices is the USB interface, which continues to be utilized from small mobile devices to large workstations. When an integrated circuit (IC) requires multiple one-to-one Universal Serial Bus (USB) controllers and USB physical layer circuits, it significantly increases the chip area and tends to create situations where physical layer circuits interfere with one another, simultaneously increasing the complexity of application circuit design.

### SUMMARY

A Universal Serial Bus (USB) device and an operation method thereof, which may reduce the chip area and prevent mutual interference between physical layer circuits, are provided in the disclosure.

The USB device of the disclosure includes multiple USB controllers, a USB determining processor, and a single USB physical layer circuit. The USB determining processor is coupled to the USB controllers. The USB physical layer circuit is coupled to the USB determining processor. The USB controllers take turns to reset the USB physical layer circuit during an initial setting period to obtain corresponding device controller initial addresses and descriptors. The USB determining processor queues a ready flag of a USB controller indicating that data corresponding to a host request of a host is ready into a ready flag queue waiting list. The USB determining processor transmits data of a corresponding USB controller to the host according to the ready flag queue waiting list. When a ready flag corresponding to a USB controller polled by the host is located at a first position in the ready flag queue waiting list, the USB determining processor transmits data of the corresponding USB controller to the host.

In one embodiment of the disclosure, during the initial setting period, when one of the USB controllers resets the USB physical layer circuit to obtain a corresponding device controller initial address and a corresponding descriptor of the device controller initial addresses and descriptors, USB controllers that have obtained the corresponding device controller initial addresses do not respond to the host and remains in a previous state.

In an embodiment of the disclosure, the previous state includes a state of not changing an obtained device controller initial address or a state of waiting to reset the USB physical layer circuit.

In one embodiment of the disclosure, the ready flag is arranged in the ready flag queue waiting list in a first-in-first-out manner.

In one embodiment of the disclosure, when the ready flag corresponding to the USB controller polled by the host is not located at the first position in the ready flag queue waiting list, the USB determining processor transmits a negative acknowledgment signal to the host through the USB physical layer circuit.

In one embodiment of the disclosure, the USB controllers operate in a same speed class.

In one embodiment of the disclosure, the host does not clear a stored device controller initial address.

An operation method of a USB device is also provided in the disclosure. The USB device includes multiple USB controllers, a USB determining processor, and a single USB physical layer circuit. The USB determining processor is coupled to the USB controllers and the USB physical layer circuit. The operation method of the USB device includes the following operation. The USB controllers are controlled to take turns to reset the USB physical layer circuit during an initial setting period to obtain corresponding device controller initial addresses and descriptors. The USB determining processor is controlled to queue a ready flag of a USB controller indicating that data corresponding to a host request of a host is ready into a ready flag queue waiting list. The USB determining processor is controlled to transmit data of a corresponding USB controller to the host according to the ready flag queue waiting list. When a ready flag corresponding to a USB controller polled by the host is located at a first position in the ready flag queue waiting list, the USB determining processor is controlled to transmit data of the corresponding USB controller to the host.

In one embodiment of the disclosure, the ready flag is arranged in the ready flag queue waiting list in a first-in-first-out manner.

In one embodiment of the disclosure, when the ready flag corresponding to the USB controller polled by the host is not located at the first position in the ready flag queue waiting list, the USB determining processor is controlled to transmit a negative acknowledgment signal to the host through the USB physical layer circuit.

In one embodiment of the disclosure, the USB controllers operate in a same speed class.

Based on the above, the USB controllers of the embodiment of the disclosure take turns to reset the USB physical layer circuit during an initial setting period to obtain corresponding device controller initial addresses and descriptors. The USB determining processor queues a ready flag of a USB controller indicating that data corresponding to a host request of a host is ready into a ready flag queue waiting list. The USB determining processor transmits data of a corresponding USB controller to the host through the USB physical layer circuit according to the ready flag queue waiting list. When a ready flag corresponding to a USB controller polled by the host is located at a first position in the ready flag queue waiting list, the USB determining processor transmits data of a corresponding USB controller to the host. In this way, by employing an architecture where multiple USB controllers share a single USB physical layer circuit, the chip area may be significantly reduced while preventing mutual interference between physical layer circuits.

In order to make the above-mentioned features and advantages of the disclosure comprehensible, embodiments accompanied with drawings are described in detail below.

### BRIEF DESCRIPTION OF THE DRAWINGS

FIG. 1 to FIG. 4 are schematic diagrams of a USB device according to an embodiment of the disclosure.

FIG. 5 is a flowchart of an operation method of a USB device according to an embodiment of the disclosure.

### DETAILED DESCRIPTION OF DISCLOSED EMBODIMENTS

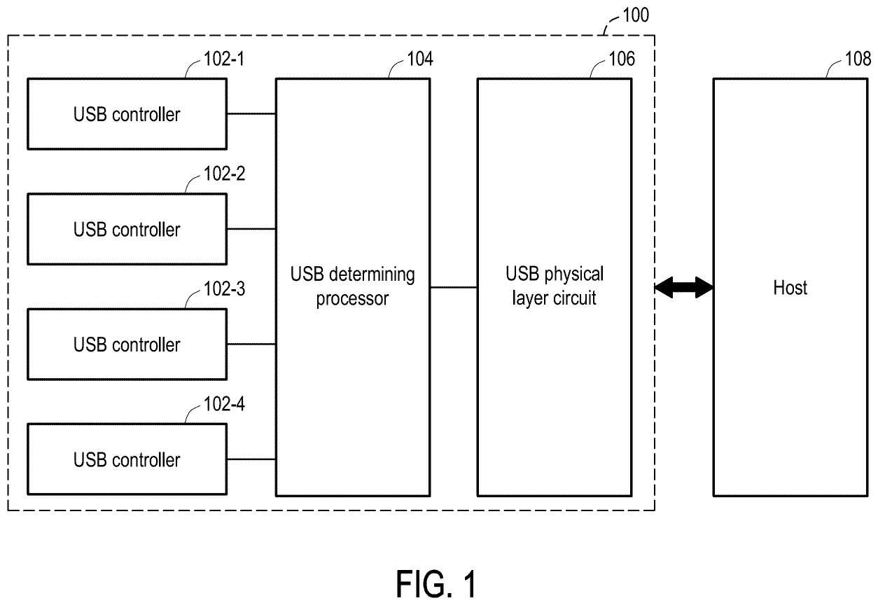

FIG. 1 is a schematic diagram of a USB device according to an embodiment of the disclosure. As shown in FIG. 1, the USB device 100 includes USB controllers 102-1 to 102-4, a USB determining processor 104, and a USB physical layer circuit 106. The USB determining processor 104 is coupled to the USB controllers 102-1 to 102-4 and the USB physical layer circuit 106. The USB controllers 102-1 to 102-4 operate in a same speed class. It should be noted that a number of USB controllers is not limited to this embodiment. In other embodiments, the USB device 100 may also include more or fewer USB controllers.

The USB controllers 102-1 to 102-4 may communicate with the host 108 through the USB determining processor 104 and the USB physical layer circuit 106. Specifically, when the USB device 100 establishes a connection with the host 108, the USB device 100 enters an initial setting period and communicates with the host 108 via Endpoint 0 to obtain device controller initial addresses and descriptors. Specifically, the USB controllers 102-1 to 102-4 may take turns to reset the USB physical layer circuit 106 during the initial setting period to obtain the respective device controller initial addresses and descriptors. In addition, when the USB controller transmits a reset request, the host 108 does not clear the device controller initial address previously stored in the firmware, in order to store the device controller initial address of the polled USB controller (e.g., the USB controllers 102-1 to 102-4) in the firmware.

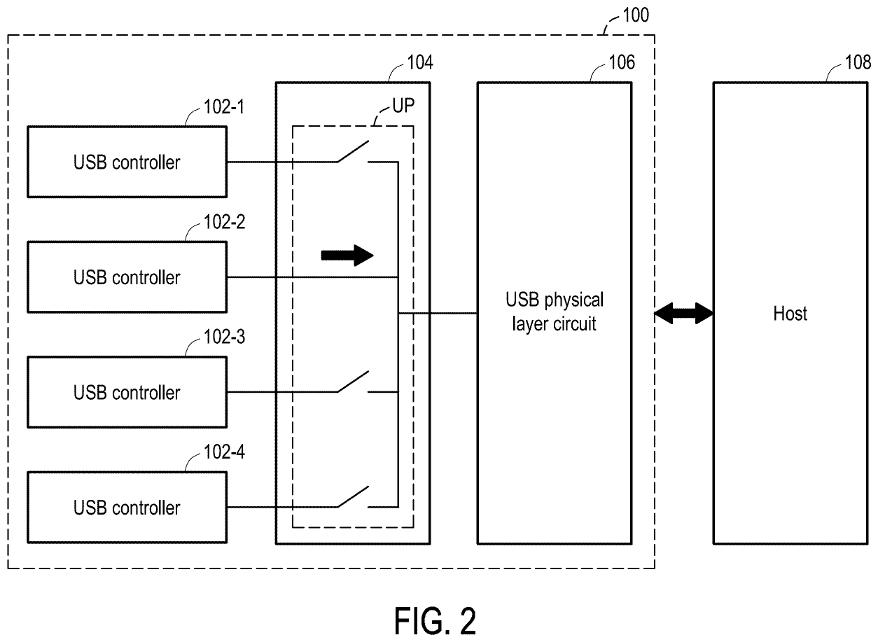

The USB determining processor 104 may include an upstream port and a downstream port. The USB determining processor 104 may control the connection status between the USB controllers 102-1 to 102-4 and the USB physical layer circuit 106. For example, during the initial setting period, when one of the USB controllers 102-1 to 102-4 resets the USB physical layer circuit 106 to obtain a corresponding device controller initial address and descriptor, the remaining USB controllers 102-1 to 102-4 do not communicate with the host 108. For example, as shown in FIG. 2, during the initial setting period, when it is the turn of the USB controller 102-2 to reset the USB physical layer circuit 106, the upstream port UP may connect the USB controller 102-2 to the USB physical layer circuit 106 and disconnect the connection between the other USB controllers 102-1, 102-3, 102-4 and the USB physical layer circuit 106. That is, during the initial setting period, only one USB controller may communicate with the host 108 through the upstream port UP and the USB physical layer circuit 106 at a time.

The USB controller 102-2 may reset the USB physical layer circuit 106 through the upstream port UP and obtain the corresponding device controller initial address and descriptor, while the USB bus controllers 102-1, 102-3, and 102-4 do not respond to the host 108 and remain in the previous state. Maintaining the previous state may, for example, be maintaining a state of not changing the obtained device controller initial address or maintaining a state of waiting to reset the USB physical layer circuit 106. For example, in the embodiment of FIG. 2, assuming that the USB controller 102-1 has obtained the corresponding device controller initial address and descriptor, while the USB controllers 102-3 and 102-4 have not yet obtained the corresponding device controller initial address and descriptor, when the USB controller 102-2 resets the USB physical layer circuit 106 through the upstream port UP to obtain the corresponding device controller initial address and descriptor, the USB controller 102-1 does not respond to the host 108 and maintains its obtained device controller initial address and descriptor unchanged. In addition, the USB controllers 102-3 and 102-4 do not respond to the host 108 and maintain the waiting state, so that after the USB controller 102-2 completes the handshake, the USB controllers 102-3 and 102-4 take turns to reset the USB physical layer circuit 106 in the same manner, thereby obtaining the corresponding device controller initial address and descriptor.

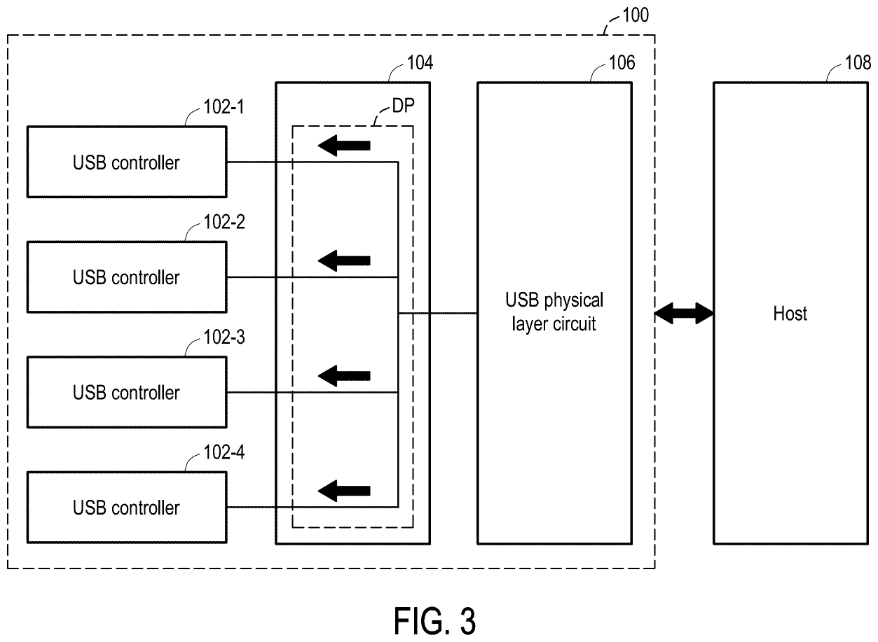

After the USB controllers 102-1 to 102-4 complete the setting of the device controller initial addresses and descriptors, the USB device 100 may exit the initialization phase and enter the normal operation mode to start general communication with the host 108, such as data transmission. For example, as shown in FIG. 3, the host 108 may transmit a data packet to the USB controllers 102-1 to 102-4 via the downstream port DP. The USB controllers 102-1 to 102-4 may check the address of the data packet, receive the data packet when the address of the data packet matches the device controller initial address, and send an acknowledgment signal (ACK) through the USB determining processor 104 to reply to the host 108 that the data packet has been received, otherwise the data packet is ignored without responding. This may prevent the USB controller that is not the transmission target of the data packet from being interfered.

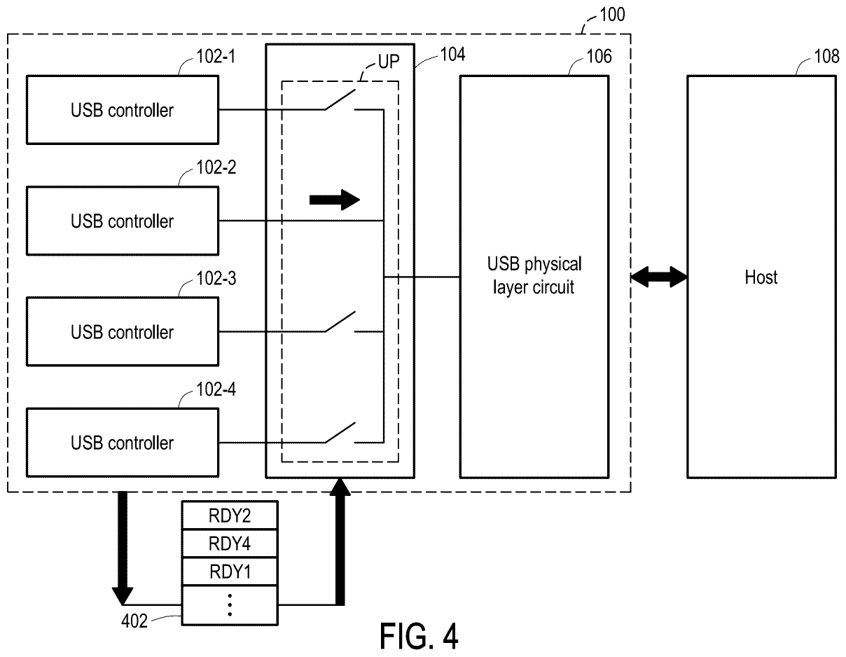

In addition, when the host 108 transmits a host request to the USB controller, the USB controller responds to the host request in a manner as shown in FIG. 4. Taking the host 108 transmitting a host request to the USB controller 102-2 as an example, the USB controller 102-2 may respond to the host request and provide a ready flag RDY2 to the USB determining processor 104 after the corresponding data is ready. The USB determining processor 104 may queue the ready flag RDY2 provided by the USB controller 102-2 into the ready flag queue waiting list 402, for example, in a first-in-first-out manner.

For example, in the embodiment of FIG. 4, the order of the USB controllers in which the data corresponding to the host request of the host 108 is ready is the USB controller 102-2, the USB controller 102-4, and the USB controller 102-1. The USB determining processor 104 arranges the ready flags RDY2, RDY4, and RDY1 provided by the USB controllers 102-2, 102-4, and 102-1 after the data in response to the host request is ready in the ready flag queue waiting list 402 in sequence according to the first-in-first-out manner. The USB determining processor 104 may transmit the data of the USB controller to the host 108 through the USB physical layer circuit 106 according to the ready flag queue waiting list 402. Furthermore, the host 108 may read the data of the USB controller in a polling manner, and the USB determining processor 104 may decide whether to transmit a negative acknowledgment signal (NAK), data, or an acknowledgment signal (ACK) to the host 108 according to whether the ready flag corresponding to the USB controller polled by the host 108 is located at a first position in the ready flag queue waiting list 402.

For example, in FIG. 4, when the host 108 polls the USB controller 102-4, since the first position in the ready flag queue waiting list 402 is the ready flag RDY2 corresponding to the USB controller 102-2, the USB determining processor 104 may transmit a negative acknowledgment signal (NAK) to the host 108 through the USB physical layer circuit 106 to respond to the host request. When the host 108 polls the USB controller 102-2, the USB determining processor 104 may transmit an acknowledgment signal (ACK) to the host 108 through the USB physical layer circuit 106, or read data corresponding to the USB controller 102-2 and transmit the data to the host 108. Similarly, after the host 108 has finished reading the data from the USB controller 102-2, the ready flag RDY4 in the ready flag queue waiting list 402 becomes the first position. Thus, only when the host 108 polls the USB controller 102-4, the USB determining processor 104 will transmit an acknowledgment signal (ACK) to the host 108 through the USB physical layer circuit 106, or read the data corresponding to the USB controller 102-4 and transmit the data to the host 108.

As shown in the above embodiments, the USB device 100 may still perform communication processing of multiple USB controllers in an orderly manner even if only one USB physical layer circuit 106 is used, and may achieve the effects of reducing chip area, preventing interference between USB physical layer circuits, preventing eye diagram window reduction and performance degradation, and reducing power consumption. In addition, since the USB determining processor 104 functions as a virtual hub, the configuration of the hub may be omitted. In addition, using only one USB physical layer circuit 106 may also significantly reduce the configuration of pins and pads and reduce layout complexity, such that automatic placement & routing (APR) and layout are more convenient, thereby reducing design costs and error rates. In addition, the field programmable gate array (FPGA) requires only one daughterboard of a USB physical layer circuit, which facilitates verification and improves the utilization rate of the evaluation board (EVB) and reduces the difficulty of user design.

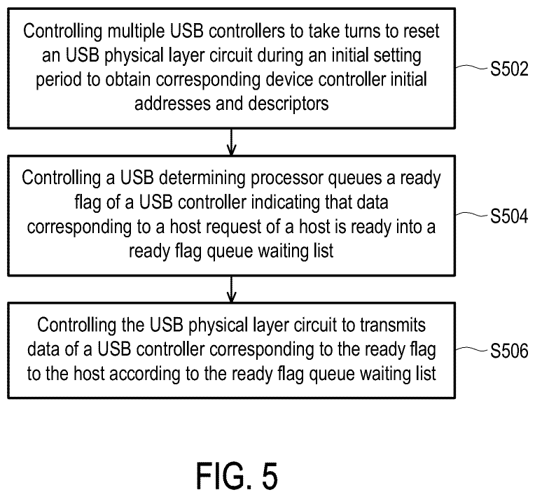

FIG. 5 is a flowchart of an operation method of a USB device according to an embodiment of the disclosure. The USB device includes multiple USB controllers, a USB determining processor, and a USB physical layer circuit. The USB determining processor is coupled to each of the USB controllers and the USB physical layer circuit. Each of the USB controllers operate in a same speed class. It may be seen from the above embodiments that the operation method of the USB device may at least include the following steps. Firstly, multiple USB controllers are controlled to take turns to reset an USB physical layer circuit during an initial setting period to obtain corresponding device controller initial addresses and descriptors (step S502). When one of the USB controllers is controlled to reset the USB physical layer circuit to obtain a corresponding device controller initial address and descriptor, the remaining USB controllers may be controlled not to respond to the host and remain in a previous state. The previous state may, for example, includes a state of not changing an obtained device controller initial address or a state of waiting to reset the USB physical layer circuit. In addition, when the USB controller transmits a reset request, the host does not clear the corresponding device controller initial address previously stored in the firmware through the USB physical layer circuit, in order to store the device controller initial address of each of the USB controllers in the firmware. Next, the USB determining processor is controlled to queue a ready flag of a USB controller indicating that data corresponding to a host request of a host is ready into a ready flag queue waiting list (step S504). The ready flag may be, for example, arranged in the ready flag queue waiting list in a first-in-first-out manner. Then, the USB physical layer circuit is controlled to transmit the data of the USB controller corresponding to the ready flag to the host according to the ready flag queue waiting list (step S506). When the ready flag corresponding to the USB controller polled by the host indicates it is located at the first position in the ready flag queue waiting list, the USB determining processor is controlled to transmit an acknowledgment signal to the host through the USB physical layer circuit, or read the data of the polled USB controller and transmit the data to the host. When the ready flag corresponding to the USB controller polled by the host indicates that it is not located at the first position in the ready flag queue waiting list, the USB determining processor is controlled to transmit a negative acknowledgment signal to the host through the USB physical layer circuit to respond to the host request.

To sum up, the USB controllers of the embodiment of the disclosure take turns to reset the USB physical layer circuit during an initial setting period to obtain corresponding device controller initial addresses and descriptors. The USB determining processor queues a ready flag of a USB controller indicating that data corresponding to a host request of a host is ready into a ready flag queue waiting list. The USB determining processor transmits data of a corresponding USB controller to the host through the USB physical layer circuit according to the ready flag queue waiting list. When a ready flag corresponding to a USB controller polled by the host is located at a first position in the ready flag queue waiting list, the USB determining processor transmits data of a corresponding USB controller to the host. In this way, by employing an architecture where multiple USB controllers share a single USB physical layer circuit, advantages may be achieved, such as significant reduction in chip area, prevention of interference between physical layer circuits, prevention of eye diagram window reduction, omission of hub configuration, reduction in pin and pad configurations, decreased layout complexity, and the requirement of only one daughterboard of the USB physical layer circuit for the field programmable gate array, facilitating verification and improving the utilization rate of the evaluation board, and reducing the difficulty of user design.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A universal serial bus (USB) device, comprising:
a plurality of USB controllers;
a USB determining processor, coupled to the USB controllers; and
a USB physical layer circuit, coupled to the USB determining processor, wherein the USB controllers take turns to reset the USB physical layer circuit during an initial setting period to obtain corresponding device controller initial addresses and descriptors, the USB determining processor queues a ready flag of a USB controller of the USB controllers indicating that data corresponding to a host request of a host is ready into a ready flag queue waiting list, the USB determining processor transmits data of a corresponding USB controller to the host according to the ready flag queue waiting list, wherein when a ready flag corresponding to a USB controller polled by the host is located at a first position in the ready flag queue waiting list, the USB determining processor transmits data of the corresponding USB controller to the host.

2. The universal serial bus device according to claim 1, wherein during the initial setting period, when one of the USB controllers resets the USB physical layer circuit to obtain a corresponding device controller initial address and a corresponding descriptor of the device controller initial addresses and descriptors, USB controllers that have obtained the corresponding device controller initial addresses do not respond to the host and remains in a previous state.

3. The universal serial bus device according to claim 1, wherein the previous state comprises a state of not changing an obtained device controller initial address or a state of waiting to reset the USB physical layer circuit.

4. The universal serial bus device according to claim 1, wherein the ready flag is arranged in the ready flag queue waiting list in a first-in-first-out manner.

5. The universal serial bus device according to claim 1, wherein when the ready flag corresponding to the USB controller polled by the host is not located at the first position in the ready flag queue waiting list, the USB determining processor transmits a negative acknowledgment signal to the host through the USB physical layer circuit.

6. The universal serial bus device according to claim 1, wherein the USB controllers operate in a same speed class.

7. The universal serial bus device according to claim 1, wherein the host does not clear a stored device controller initial address.

8. An operation method of a universal serial bus (USB) device, wherein the USB device comprises a plurality of USB controllers, a USB determining processor, and a USB physical layer circuit, the USB determining processor is coupled to the USB controllers and the USB physical layer circuit, the operation method of the USB device comprises:
controlling the USB controllers to take turns to reset the USB physical layer circuit during an initial setting period to obtain corresponding device controller initial addresses and descriptors;
controlling the USB determining processor to queue a ready flag of a USB controller of the USB controllers indicating that data corresponding to a host request of a host is ready into a ready flag queue waiting list; and
controlling the USB determining processor to transmit data of a corresponding USB controller to the host according to the ready flag queue waiting list, wherein when a ready flag corresponding to a USB controller polled by the host is located at a first position in the ready flag queue waiting list, the USB determining processor is controlled to transmit data of the corresponding USB controller to the host.

9. The operation method of the universal serial bus device according to claim 8, wherein the ready flag is arranged in the ready flag queue waiting list in a first-in-first-out manner.

10. The operation method of the universal serial bus device according to claim 8, wherein when the ready flag corresponding to the USB controller polled by the host is not located at the first position in the ready flag queue waiting list, the USB determining processor is controlled to transmit a negative acknowledgment signal to the host through the USB physical layer circuit.

11. The operation method of the universal serial bus device according to claim 8, wherein the USB controllers operate in a same speed class.
